(19) United States
(12) Patent Application Publication
(10) Pub. No.: US 2025/0361383 A1
(43) Pub. Date: Nov. 27, 2025

(54) RESIN COMPOSITION AND MANUFACTURING METHOD THEREOF

(71) Applicant: Coretronic Corporation, Hsin-Chu (TW)

(72) Inventors: Kuan-Hua Chen, Hsin-Chu (TW); Ching-Nan Chuang, Hsin-Chu (TW); Chen-Ting Jang, Hsin-Chu (TW)

(73) Assignee: Coretronic Corporation, Hsin-Chu (TW)

(21) Appl. No.: 19/207,379

(22) Filed: May 14, 2025

(30) Foreign Application Priority Data
May 22, 2024 (CN) 202410635589.6

(51) Int. Cl. C08K 9/00; C01B 32/194; C08J 3/20; C08K 3/04; H01B 3/00

(52) U.S. Cl. CPC C08K 9/00; C01B 32/194; C08J 3/201; C08K 3/04; C08J 2369/00; C08K 2201/001; C08K 2201/005; C08K 2201/011; H01B 3/004

(57) ABSTRACT

The disclosure provides a resin composition and a manufacturing method thereof. The resin composition includes a resin carrier, conductive carbon black, and graphene. The carbon black and graphene are dispersed in the resin carrier. Based on a total weight of the resin composition, the resin carrier accounts for 93 wt % to 97 wt %, the conductive carbon black accounts for 1 wt % to 3 wt %, and the graphene accounts for 2 wt % to 4 wt.

### CROSS-REFERENCE TO RELATED APPLICATION

This application claims the priority benefit of China application serial no. 202410635589.6, filed on May 22, 2024. The entirety of the above-mentioned patent application is hereby incorporated by reference herein and made a part of this specification.

### BACKGROUND

### Technical Field

The disclosure relates to a resin composition and a manufacturing method thereof.

### Description of Related Art

In the electronic industry, resins (plastic members) play an important role and are often used as insulating elements. For example, a scope of application of the resin includes a carrier board of a circuit board, a housing of an electronic product, an adhesive, etc. According to different requirements, resins with different physical properties may be selected.

However, in a process of manufacturing or applying resin products, issues of accumulation of electrostatic charges are often encountered. For example, a surface of the resin product is carried with the electrostatic charges due to friction. The electrostatic charges may cause a variety of negative effects. For example, they may cause adsorption of dust, thereby causing damage to the product. In addition, the electrostatic charges may cause electric shock, resulting in hazards of fire or explosion. In order to solve the issues, there is an urgent need to develop a new type of resin composition that may effectively avoid the accumulation of the electrostatic charges.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one, a part, or all of the above objectives or other objectives, at least one embodiment of the disclosure provides a resin composition, including a resin carrier, conductive carbon black, and graphene. The conductive carbon black and the graphene are dispersed in the resin carrier. Based on a total weight of the resin composition, the resin carrier accounts for 93 wt % to 97wt %, the conductive carbon black accounts for 1 wt % to 3 wt %, and the graphene accounts for 2 wt % to 4 wt %.

In order to achieve one, a part, or all of the above objectives or other objectives, at least one embodiment of the disclosure provides a manufacturing method of a resin composition, including the following steps. A graphite material and an intercalating agent are mixed in a solvent, and a graphene solution is obtained by using an ultrasonic vibration treatment. The graphene solution is mixed with a stabilizer to obtain a graphene dispersion liquid. A drying process is performed on the graphene dispersion liquid to obtain graphene in a state of dry powder. At least part of the intercalating agent and at least part of the stabilizer are removed in the drying process. The graphene in the state of dry powder, conductive carbon black, and a resin carrier are mixed to obtain the resin composition. Based on a total weight of the resin composition, the resin carrier accounts for 93 wt % to 97 wt %, the conductive carbon black accounts for 1 wt % to 3 wt %, and the graphene accounts for 2 wt % to 4 wt %.

### BRIEF DESCRIPTION OF THE DRAWINGS

FIG. 1 is a schematic cross-sectional view of a resin composition according to an embodiment of the disclosure.

FIG. 2 is a flow chart of a manufacturing method of the resin composition in FIG. 1.

### DETAILED DESCRIPTION OF DISCLOSED EMBODIMENTS

It is to be understood that both the foregoing and other detailed descriptions, features and advantages are intended to be described more comprehensively by providing an embodiment accompanied with figures hereinafter. Directional terms mentioned in the following embodiments, such as upper, lower, left, right, front, or rear merely refer to directions in the accompanying drawings. Therefore, the directional terms are used to illustrate rather than limit the disclosure.

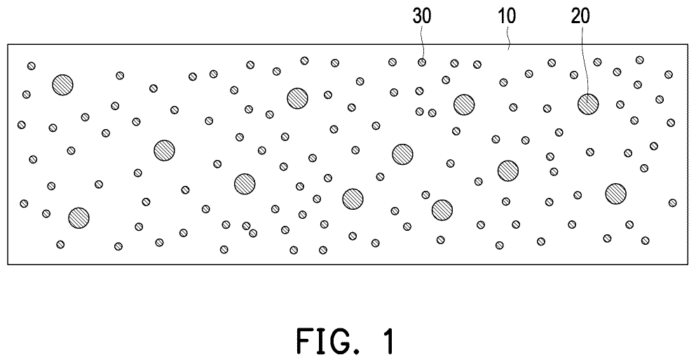

Referring to FIG. 1, in some embodiments of the disclosure, a resin composition including a resin carrier 10, conductive carbon black 20, and graphene 30 is provided. The resin composition forms, for example, a plastic member, a housing, or a plate body. A specific description of each of components of the resin composition is as follows.

### Resin Carrier

The resin carrier 10 includes polycarbonate (PC) or other suitable resin materials (e.g., polymethyl methacrylate (PMMA), polyethylene terephthalate (PET)). Polycarbonate is an amorphous polymer engineering material having excellent impact resistance, thermal stability, glossiness, and flame retardant properties. Due to excellent electrical insulating properties thereof, polycarbonate products are well suited for industrial insulating materials, mainly due to high surface resistance or volume resistivity thereof.

In the resin composition, the resin carrier 10 is used as a main component. Adding other additives other than the resin carrier 10 to the resin composition may cause an issue of precipitation or dispersion of the other additives. In order to avoid the aforementioned issues, in addition to necessary additives, the higher a proportion of the resin carrier 10 in the resin composition, the better. In some embodiments, based on a total weight of the resin composition, the resin carrier 10 accounts for 93 wt % to 97 wt % (weight percent), and the other additives account for 3 wt % to 7 wt %. In other embodiments, the resin carrier 10 accounts for 93 wt % to 96.5 wt %, and the other additives account for 3 wt % to 7 wt %. Specifically, in this embodiment, the resin carrier refers to a single resin material (e.g., polycarbonate) or a mixture of multiple resin materials, but does not include non-resin materials.

### Conductive Carbon Black

The conductive carbon black 20 is dispersed in the resin carrier 10. For example, the conductive carbon black 20 includes multiple conductive carbon black units (or referred to as conductive carbon black particles), and the conductive carbon black units are evenly distributed in the resin carrier 10.

In some embodiments, the conductive carbon black 20 includes a carbon element of 95 wt % to 100 wt % and other components of 0 wt % to 5 wt %, and the other components include at least one of an oxygen element, a sulfur element, and a nitrogen element. For example, the other components in the conductive carbon black 20 include ash. Specifically, a type of the conductive carbon black 20 may be conductive channel black, conductive furnace black, super-conductive furnace black, acetylene carbon black (acetylene black), etc. In an embodiment of the disclosure, the conductive carbon black 20 may include only one of the above carbon blacks. In another embodiment, the conductive carbon black 20 may include a mixture of the above carbon blacks, which may, for example, include the conductive channel black and the acetylene black, and the a ratio of weight percent thereof may be, for example, between 0.01 and 99.

In some embodiments, the conductive carbon black 20 does not exist as a single particle, but is formed by primary carbon black particles with a diameter of about 10 nm to 500 nm tightly connected into a grape bunch-shaped aggregate. This form constitutes a primary structure of the carbon black. The primary structures aggregate into a greater structure called an agglomerate due to the mutual attraction of the Van Der Waals force. Finally, after a pelletization process, the conductive carbon black 20 used herein may be obtained. In some embodiments, a particle size of the conductive carbon black (or referred to as the conductive carbon black unit) obtained after the pelletization process is 30 nm to 65 nm.

In the resin composition of the disclosure, addition of the conductive carbon black 20 helps to increase electrical conductivity of the resin composition, thereby improving an issue of static electricity of the resin composition. However, if a content of the conductive carbon black 20 in the resin composition is too high, there will be an issue of precipitation of the conductive carbon black 20 on a surface of the resin composition. In the disclosure, addition of the graphene 30 to the resin composition helps to reduce the required content of the conductive carbon black 20 in the resin composition. In some embodiments, based on the total weight of the resin composition, the conductive carbon black 20 accounts for 1 wt % to 3 wt %.

### Graphene

The graphene 30 is dispersed in the resin carrier 10. For example, the graphene 30 includes multiple graphene units (or referred to as graphene particles), and the graphene units are evenly distributed in the resin carrier 10.

The graphene 30 is a two-dimensional material formed by an arrangement of carbon atoms in a single layer (or less than 10 layers), which has extremely high electron mobility and therefore has excellent conductivity. It is one of the best conductive materials that are known.

Thermal conduction performance of the graphene 30 is excellent, even higher than that of copper, which makes it an ideal material in a field of thermal management, and may be used to prepare high-performance heat dissipation materials, composite materials with high thermal conductivity, etc. Compared to one-dimensional carbon nanotubes that are prone to entanglement and agglomeration, two-dimensional graphene may be better dispersed in the resin carrier. In some embodiments, the graphene 30 described herein is prepared by an intercalation method.

In some embodiments, an average particle size of the graphene (or referred to as the graphene unit) 30 is 5 um to 10 um (microns). In some embodiments, an oxygen content in the graphene 30 is less than or equal to 0.1 wt %. In some embodiments, the addition of the graphene 30 helps reduce the required content of the conductive carbon black 20 in the resin composition. In some embodiments, based on the total weight of the resin composition, the graphene 30 accounts for 2 wt % to 4 wt %. In some embodiments, in the resin composition, a ratio of weight percent of the graphene 30 to weight percent of the conductive carbon black 20 is greater than or equal to 1.3 and less than or equal to 2. If the ratio of the weight percent of the graphene 30 to the weight percentage of the conductive carbon black 20 is greater than 2, it will cause conductivity of the resin composition to be too high, resulting in an issue of a conductor. If the ratio of the weight percent of the graphene 30 to the weight percent of the conductive carbon black 20 is less than 1.3, it will cause physical properties and the conductivity of the resin composition to deteriorate.

The resin composition in the disclosure has simple components. Specifically, a total weight of the resin carrier 10, the conductive carbon black 20, and the graphene 30 accounts for 96 wt % or more of the resin composition, preferably 99.5 wt % or more. Other components in the resin composition may be impurities remaining in a manufacturing process. Here, if the impurities are controlled to less than 0.5 wt %, they can be ignored. With such a configuration, an issue of dispersion or precipitation of the components in the resin composition during processing may be reduced. For example, if the resin composition contains too many other organic additives (e.g., residual intercalating agents and/or residual stabilizers), when the resin composition is used in a semiconductor processes, the organic additives are likely to escape in a vacuum process or heating process and cause contamination issues. The above issues may be avoided by using the resin composition in the disclosure.

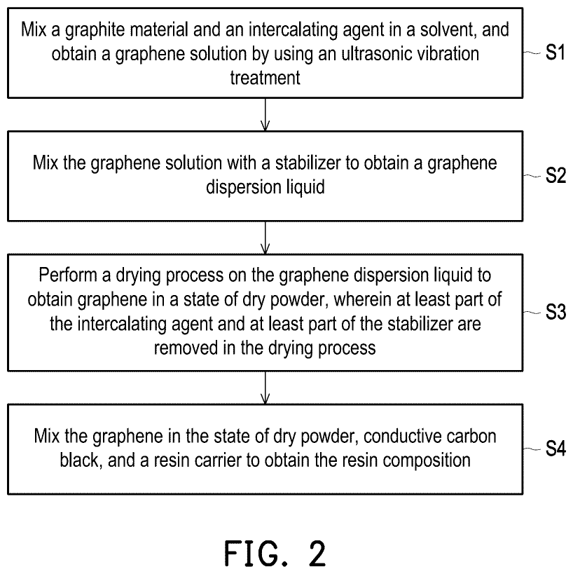

Each of steps of preparing the resin composition in the disclosure will be further described below with reference to FIG. 2. It should be noted that the steps described below are not intended to limit the disclosure, and other additional steps may be included between each of the steps.

First, in step S1, a graphite material and the intercalating agent are mixed in a solvent. In some embodiments, the graphite material refers to, for example, pulverized graphite or other types of graphite. In some embodiments, the intercalating agent includes strong acids such as sulfuric acid, nitric acid, perchloric acid, and potassium permanganate, sodium nitrate, hydrogen peroxide, or other suitable materials or a combination of the above materials. In some embodiments, the solvent includes deionized water, other suitable materials, or a combination of the above materials.

After mixing or in a mixing process, the graphite material, the intercalating agent, and the solvent are treated by using ultrasonic vibration. The graphite material may include multiple layers (e.g., hundreds, thousands, or more layers) of graphite. The intercalating agent is inserted between graphite layers, and the graphite layers are separated by the ultrasonic vibration, thereby obtaining a graphene solution.

Next, in step S2, the graphene solution is mixed with a stabilizer to obtain a graphene dispersion liquid. In some embodiments, the stabilizer is added to the graphene solution in a process of ultrasonic vibration. In some embodiments, in the graphene dispersion liquid, the stabilizer is attached to a surface of the graphene, thereby enabling the graphene to be stably dispersed in the solvent. Therefore, in some embodiments, the stabilizer may also be referred to as a dispersant. In some embodiments, the stabilizer includes hydrocarbon solvents, halogenated solvents, alcoholic solvents, or other suitable materials or a combination of the above materials.

In some embodiments, the graphene dispersion liquid includes the solvent of 1 wt % to 5 wt %, graphene of 90 wt % to 94 wt %, the intercalating agent of 1 wt % to 2.5 wt %, and the stabilizer of 0.1 wt % to 0.5 wt %.

In step S3, after the graphene dispersion liquid is obtained, a drying process is performed on the graphene dispersion liquid to obtain graphene in a state of dry powder. For example, the solvent, at least part of the intercalating agent, and at least part of the stabilizer in the graphene dispersion liquid are removed through the drying process (e.g., the vacuum process and/or the heating process). In this step, the intercalating agent and the stabilizer are removed as much as possible, thereby preventing the intercalating agent and the stabilizer from remaining in the finally obtained resin composition and causing the issue of dispersion. In some embodiments, in the graphene in the state of dry powder, residues of the intercalating agent and the stabilizer account for 0 wt % to 0.1 wt %.

In step S4, the obtained graphene in the state of dry powder, the conductive carbon black, and the resin carrier are mixed to obtain the resin composition. For example, the obtained graphene in the state of dry powder, the conductive carbon black, and the uncured resin carrier are mixed and cured (e.g., cooled) to obtain the resin composition. In some embodiments, a twin-screw extruder is used to melt and knead the graphene in the state of dry powder, the conductive carbon black, and the resin carrier, and finally the resin composition is extruded. In the disclosure, the graphene in the state of dry powder is added to the twin-screw extruder instead of the graphene in a dispersion liquid state, otherwise an extrusion process will be difficult.

Table 1 provides a comparison of properties of the resin compositions of Example 1, Comparative Example 1, and Comparative Example 2 in the disclosure. To facilitate the comparison of differences in the properties between the example and the comparative examples, in Example 1 and Comparative Example 1 of Table 1, the conductive carbon black only includes acetylene black, for example. In Example 1 of Table 1, the resin composition includes polycarbonate of 93 wt % to 97 wt %, acetylene black of 1 wt % to 3 wt %, and graphene of 2 wt % to 4 wt %. In Comparative Example 1 of Table 1, the resin composition includes polycarbonate of 80 wt % to 90 wt % and acetylene black of 10 wt % to 20 wt %. In Comparative Example 2 of Table 1, the resin composition includes polycarbonate of 90 wt % to 95 wt % and carbon nanotubes of 5 wt % to 10 wt %.

| | | Comparative | Comparative |
|---|---|---|---|
| | Example 1 | Example 1 | Example 2 |
| Specific gravity | 1.2 | 1.22 | 1.22 |
| Bending strength (Mpa)) | 99 | 83 | 75 |
| Bending modulus (Mpa)) | 2980 | 2705 | 2605 |
| Impact strength (KJ/m²)) | 12.9 | 8.8 | 5 |
| Tensile strength (Mpa)) | 58 | 58 | 52 |
| Stretch rate (%)) | 36 | 24 | 20 |
| Surface resistance (ohm/sq)) | 10³ | 10⁵ | 10⁵ |

In Table 1, a measurement standard for the bending strength is ASTM D790, a measurement standard for the bending modulus is ASTM D790, a measurement standard for the impact strength is ASTM D256, a measurement standard for the tensile strength is ASTM D638, and a measurement standard for the stretch rate is ASTM D638. According to Table 1, the resin composition of Example 1 in the disclosure has better mechanical properties and lower surface resistance than the resin compositions of Comparative Example 1 and Comparative Example 2.

Based on the above, the resin composition according to the embodiment of the disclosure has at least one of the following advantages. The issue of precipitation of the conductive carbon black in the resin composition is reduced. The issue of agglomeration of graphene in the resin composition is reduced. The mechanical properties and the surface resistance of the resin composition is improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims

What is claimed is:

1. A resin composition, comprising:
a resin carrier, wherein based on a total weight of the resin composition, the resin carrier accounts for 93 wt % to 97 wt %;
conductive carbon black dispersed in the resin carrier, wherein based on the total weight of the resin composition, the conductive carbon black accounts for 1 wt % to 3 wt %; and
graphene dispersed in the resin carrier, wherein based on the total weight of the resin composition, the graphene accounts for 2 wt % to 4 wt %.

2. The resin composition according to claim 1, wherein a total weight of the resin carrier, the conductive carbon black, and the graphene accounts for 99.5 wt % or more of the resin composition.

3. The resin composition according to claim 1, wherein a ratio of weight percent of the graphene to weight percent of the conductive carbon black is greater than or equal to 1.3 and less than or equal to 2.

4. The resin composition according to claim 1, wherein the graphene comprises a plurality of graphene units, and the graphene units are evenly distributed in the resin carrier.

5. The resin composition according to claim 2, wherein the conductive carbon black comprises a carbon element of 95 wt % to 100 wt % and other components of 0 wt % to 5 wt %, and the other components comprise at least one of an oxygen element, a sulfur element, and a nitrogen element.

6. The resin composition according to claim 1, wherein a specific gravity of the resin composition is about 1.2, and a surface resistance of the resin composition is about 10³ ohm/sq.

7. The resin composition according to claim 1, wherein an average particle size of the graphene is 5 um to 10 um, and an average particle size of the conductive carbon black is 30 nm to 65 nm.

8. The resin composition according to claim 1, wherein the conductive carbon black comprises at least two of conductive channel black, conductive furnace black, super-conductive furnace black, and acetylene black.

9. A manufacturing method of a resin composition, comprising:
mixing a graphite material and an intercalating agent in a solvent, and obtaining a graphene solution by using an ultrasonic vibration treatment;
mixing the graphene solution with a stabilizer to obtain a graphene dispersion liquid;
performing a drying process on the graphene dispersion liquid to obtain graphene in a state of dry powder, wherein at least part of the intercalating agent and at least part of the stabilizer are removed in the drying process;
mixing the graphene in the state of dry powder, conductive carbon black, and a resin carrier to obtain the resin composition, wherein based on a total weight of the resin composition, the resin carrier accounts for 93 wt % to 97 wt %, the conductive carbon black accounts for 1 wt % to 3 wt %, and the graphene accounts for 2 wt % to 4 wt %.

10. The manufacturing method according to claim 9, wherein in the graphene in the state of dry powder, residues of the intercalating agent and the stabilizer account for 0 wt % to 0.1 wt %.

11. The manufacturing method according to claim 9, wherein the drying process comprises a vacuum process and/or a heating process.

12. The manufacturing method according to claim 9, wherein a method of mixing the graphene in the state of dry powder, the conductive carbon black, and the resin carrier comprises melting and kneading with a twin-screw extruder.
